(19) United States
(12) Patent Application Publication
(10) Pub. No.: US 2013/0104407 A1
(43) Pub. Date: May 2, 2013

(54) DETERMINING THREAD LEAD OR PITCH ACCURATELY

(71) Applicant: HEXAGON TECHNOLOGY CENTER GMBH, Heerbrugg (CH)

(72) Inventor: Alexander Ping Lee, Lake in the hills, IL (US)

(73) Assignee: HEXAGON TECHNOLOGY CENTER GMBH, Heerbrugg (CH)

(21) Appl. No.: 13/660,589

(22) Filed: Oct. 25, 2012

Related U.S. Application Data
(60) Provisional application No. 61/551,571, filed on Oct. 26, 2011.

(51) Int. Cl. G01B 5/16

(52) U.S. Cl. CPC G01B 5/163
USPC 33/199 R

(57) ABSTRACT

Apparatus and methods are provided for measuring thread leads or pitches using a metrology probe. The probe may be, for example, either a contact probe or a laser probe. The probe is mounted on the end of an articulating arm that has sensors to provide precise three-dimensional coordinates of the probe's location and orientation. The probe determines surface coordinates of the threaded object repetitively in different locations according to a program provided by a computer connected to the arm. When enough data have been gathered, the computer calculates and outputs a surface profile of the threaded object, including a lead or pitch measurement.

### CROSS REFERENCE TO RELATED APPLICATIONS

This application claims the benefit of U.S. Provisional Application No. 61/551,571, filed Oct. 26, 2011, which is incorporated herein by reference in its entirety.

### FIELD OF THE INVENTION

The present invention relates generally to a system for measuring threaded objects such as, without limitation, threaded pipes, rods, screws, bolts or threaded inserts.

### BACKGROUND OF THE ART

Pitch and lead are two measurements used to determine the shape of a threaded object, such as a pipe, rod, screw, bolt, or threaded insert. Thread “pitch” is defined as the three-dimensional distance along the thread axis between consecutive crests. However, a thread may have multiple “starts” or tracks. A thread “lead” is therefore defined as the three-dimensional distance along the thread axis that is covered by one complete rotation (360 degrees) of a single start or track, and is equal to the number of starts multiplied by the pitch. For threads having only one threaded start, by far the most common configuration, the lead is equal to the pitch. Thread measurements may be given in “threads per inch” or TPI, which is the reciprocal of the pitch (when pitch is measured in inches).

Manufacturers and users of threaded pipes in the petroleum and other industries require the threads on pipes to be cut such that the threads meet certain dimensional specifications. One of the main ways of testing whether a thread falls within these specifications is by use of a specialized lead gauge that measures thread leads, such as the gauge shown in FIG. 1. However, use of such a lead gauge is subject to human error and is relatively time consuming. Moreover, measurement of complex components having many threads of different leads or pitches requires manual use of several different lead gauges. For manufacturers that produce thousands of such components, repetitive measurement of the components to ensure that each falls within manufacturing tolerance requires thousands upon thousands of man-hours.

### SUMMARY OF ILLUSTRATED EMBODIMENTS OF THE INVENTION

Illustrated embodiments of the invention avoid the repetition and error found in the prior art by providing systems and methods for measuring threaded leads or pitches using a metrology probe. The probe may be, for example, either a contact probe or a laser probe. The probe is mounted on the end of an articulating arm that has sensors to provide precise three-dimensional coordinates of the probe's location and orientation. The probe determines surface coordinates of the threaded object repetitively in different locations according to a program provided by a computer connected to the arm. When enough data have been gathered, the computer calculates and outputs a surface profile of the threaded object, including a lead or pitch measurement.

Various embodiments of the invention advantageously repurpose articulating arms having metrology probes to solve the thread measurement problem in a new way. Various known measuring systems are capable of measuring points in space and the distances between points in space, for example, as described in U.S. patent application Ser. No. 12/748,169 filed Mar. 26, 2010, based on a provisional Application No. 61/259,105 filed Nov. 6, 2009 and published as Publication No. 2011/0107612A1, and U.S. Pat. Nos. 5,829,148 and 7,174,651. However, such prior art systems were not used to solve the problem solved by illustrative embodiments of the present invention, namely to reduce the repetition and error of manually measuring lead and pitch of threads. Various disclosed embodiments approach the problem in a different way, and arrive at a new methodology and apparatus to solve it. The solution advantageously reduces the labor cost of checking threaded objects, reduces or eliminates the need to purchase a variety of sizes of lead gauges or other such thread measurement devices, reduces the error involved in the measurement process, and is suitable for inclusion in a computer-controlled assembly line or other system for producing threaded objects made to tight manufacturing tolerances.

Accordingly, there is provided in a first embodiment a computerized method for inspecting the thread of a threaded object. The method requires placing a metrology probe at each of a number of successive locations on the thread. The metrology probe is adjustable using an articulating arm. Next, the method calls for recording a three-dimensional point of the said thread locations by a computerized metrology system coupled to the articulating arm. The method concludes by using the computerized metrology system to produce data characterizing the thread as a function of the recorded three-dimensional points of the said thread locations.

The threaded object may be a pipe, a rod, a screw, a nut, a bolt, and a threaded insert. The measurement data may include three-dimensional measurements of pairs of successive points. The measurement data may be used to determine whether the thread is within predetermined specifications, for example by comparing the measurement data to a set of reference data. A position and an orientation of the articulating arm may be controlled by the computerized metrology system. The method also may include determining at least one thread characteristic based on the measurement data. For example, the thread characteristic may be lead or pitch.

There is provided in a second embodiment a computerized thread measurement system for inspecting the thread of a threaded object. The system includes an articulating probe arm having a metrology probe, and a computerized metrology system in communication with the probe arm. The computerized metrology system is configured to do at least three things: adjust the position and orientation of the probe arm, record a three-dimensional point of the probe at each of a number of successive thread locations, and produce measurement data characterizing the thread. Some embodiments of this system may implement the method described above, and may do so without human intervention.

There is provided in a third embodiment a tangible, non-transitory computer-readable medium having embodied therein instructions for inspecting the thread of a threaded object, the instructions, which may be run on a computerized metrology system such as that described above. The instructions cause the computerized metrology system to perform the processes of recording a three-dimensional point of the probe at each of a number of successive thread locations; and producing measurement data characterizing the thread. The medium also may include instructions for positioning the articulating arm of the computerized metrology system.

### BRIEF DESCRIPTION OF THE DRAWINGS

The foregoing and advantages of the invention will be appreciated more fully from the following further description thereof with reference to the accompanying drawings wherein:

FIG. 1 shows a lead gauge as known in the art;

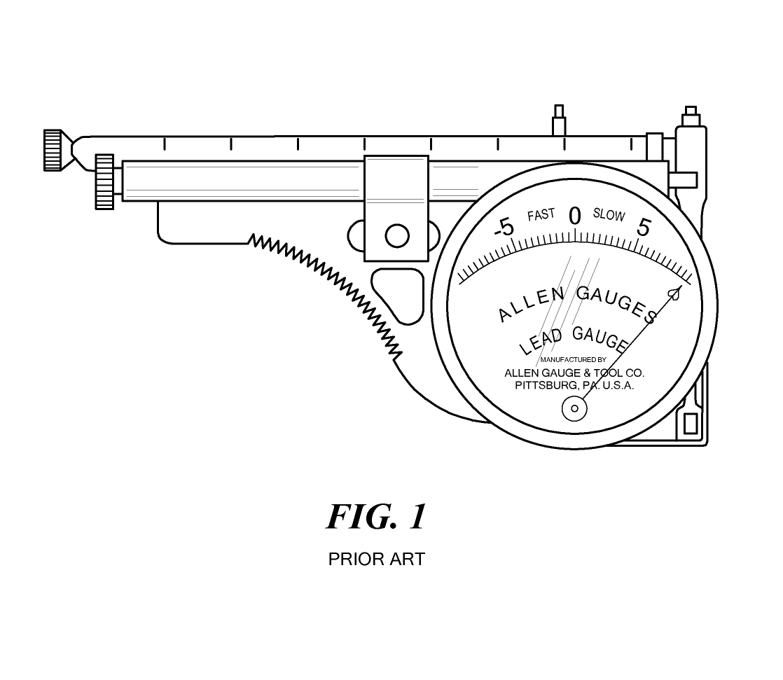

FIG. 2 schematically shows a metrology system for measuring threaded objects, in accordance with an exemplary embodiment of the present invention;

FIG. 3 schematically shows a cross-sectional view of an exemplary threaded, tapered end of a pipe; and

FIG. 4 is a logic flow diagram for thread measurement, in accordance with an exemplary embodiment.

It should be noted that the foregoing figures and the elements depicted therein are not necessarily drawn to consistent scale or to any scale. Unless the context otherwise suggests, like elements are indicated by like numerals.

### DETAILED DESCRIPTION OF SPECIFIC EMBODIMENTS

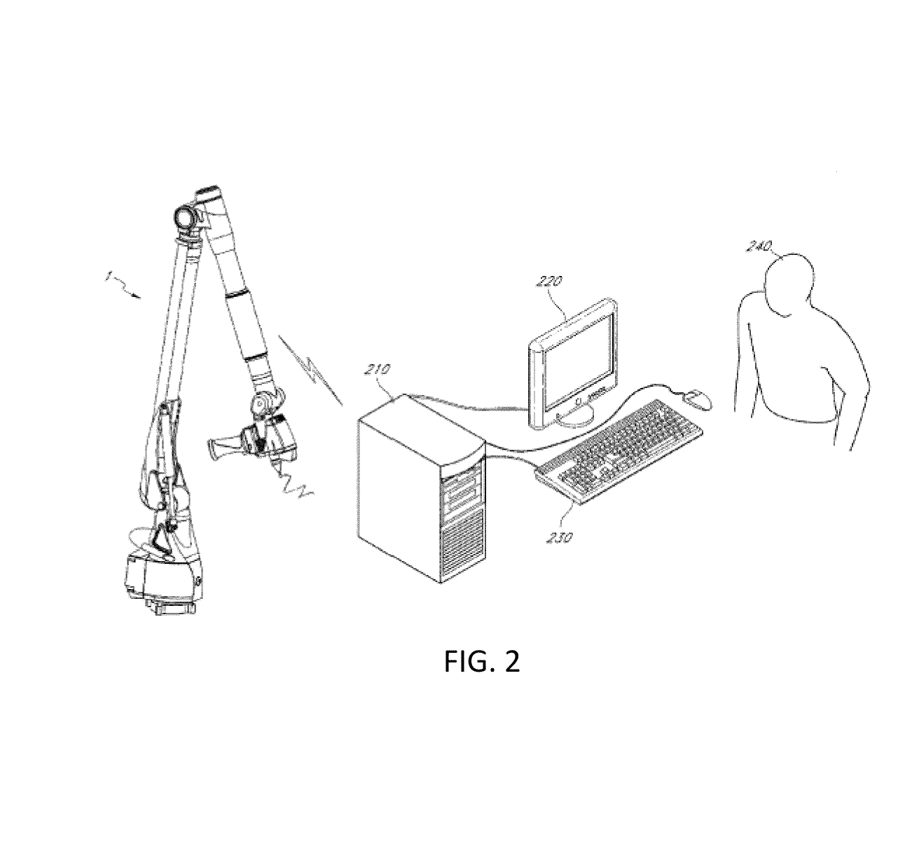

In certain embodiments, a metrology system is used to measure threads of a threaded objected. FIG. 2 schematically shows relevant components of a metrology thread measuring system in accordance with an exemplary embodiment of the present invention. Here, a portable arm 1 communicates with a computer 210, 220, 230 running metrology software that receives and interprets signals from the arm 1. The position and orientation of the portable arm 1 may be computer-controlled or manually manipulated. The measuring system is capable of measuring points in space and the distances between points in space, for example, as described in U.S. patent application Ser. No. 12/748,169 filed Mar. 26, 2010, based on a provisional Application No. 61/259,105 filed Nov. 6, 2009 and published as Publication No. 2011/0107612A1, and U.S. Pat. Nos. 5,829,148 and 7,174,651; all of these patents and patent applications are incorporated herein by reference in their entireties. The computer runs metrology software such as PC-DMIS, available from Hexagon Metrology and developed by Wilcox Associates, Inc., of North Kingstown, R.I. The metrology software is installed on an electromagnetic media or other media of the computer 210. The metrology software, among other things, allows a user 240 to view and analyze data related to measurements that are sensed by the portable arm 1.

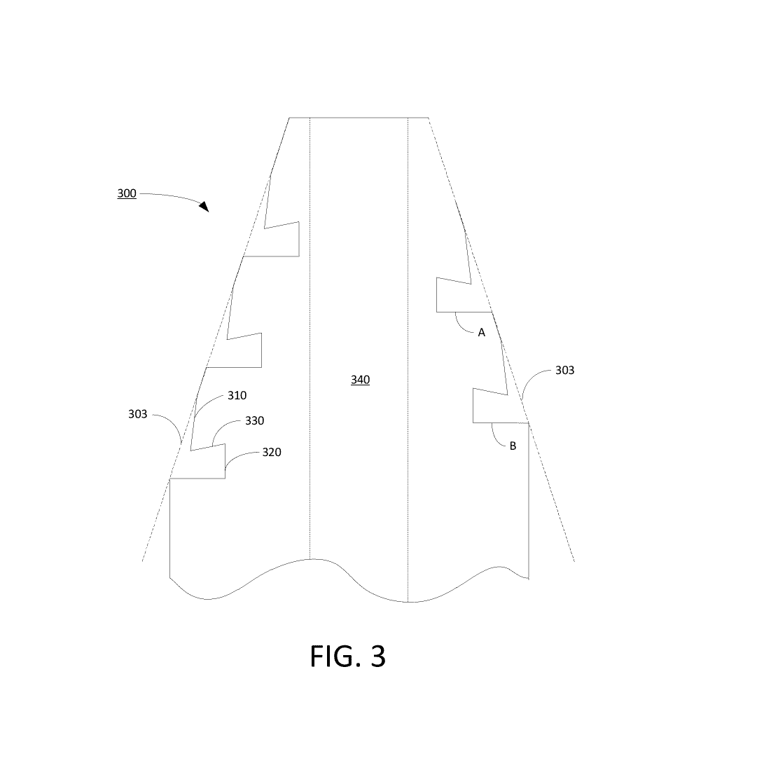

To measure the lead of threads according to this exemplary embodiment, a threaded pipe or other threaded object to be measured is placed in a jig, fixture, or other secure place so that it can be measured using the portable arm 1. FIG. 3 schematically shows a cross section of an exemplary threaded, tapered end of a pipe. As is well known in the art, the thread is cut on the end in a helical pattern. The tapered end 300 of the pipe shown in FIG. 3 shows only two and one half turns of the thread for illustrative purposes, but it may have any number of turns. Moreover, although not shown in FIG. 3, the threads would extend around the entire outer surface of the threaded end 300, usually in a helical pattern or other pattern formed by cutting the thread with relative movement between the cutting tool and the pipe or bar along the axis of the pipe or bar.

The particular thread shown in FIG. 3 is characterized by a land 310 and a groove 320 and a reverse flank 330. The land 310 in this example is clipped, meaning that it has been machined down from the surface it would otherwise have if the overall tapered thread 300 were to outline a cone (the un-machined surface profile is shown by reference number 303 in FIG. 3). The reverse flank 330 forms a non-perpendicular and acute angle to the groove 320. It should be noted that the present invention is not limited to or by the exemplary thread profile shown in FIG. 3; rather, embodiments of the present invention may be used to measure virtually any thread profile on any of a wide variety of threaded objects. For example, an internal channel 340 of a pipe is shown for reference, although the present invention is not limited to threaded pipes.

To measure the lead or pitch, the probe 2 (shown in FIG. 2) is placed on one portion A of the thread, and a measurement is collected by the measuring system shown in FIG. 2. The probe may be, for example, a ruby ball stylus type probe, although other types of probes may be used. As described in U.S. patent application Ser. No. 12/748,169, and in U.S. Pat. No. 5,829,148, measurement collection may be triggered by the user 240 pressing a button on the portable arm 1. Alternatively, measurement collection may be triggered automatically by the measurement system itself. In any case, such triggering causes the measuring system to record a point. The probe 2 is then placed on another portion B of the thread, and measurement collection is triggered to record this point. In some embodiments, the system is operated so as to continuously collect points, e.g., by successively moving the probe to different points along the contour of the thread (e.g., along the longitudinal axis of the object) and triggering measurement collection at each point to collect a number of measured points associated with the surfaces of the thread.

While FIG. 3 shows a pipe, embodiments generally can be used in connection with any threaded object, including objects with internal threads (sometimes in the petroleum industry called boxes). Thus, for example, embodiments may be used to measure threaded pipes, rods, screws, nuts, bolts, threaded inserts, etc.

When a sufficient number of measurements have been recorded, the measuring system is triggered to stop collecting points. The metrology software can then produce measurements of the three-dimensional distances between various points, for example between a point measured on the surface of thread portion A and a point measured on the surface of thread portion B. The metrology software processes that measurement data, for example to sort it using techniques known in the art, so that the smallest measurement between a point on portion A and a point on portion B represents the lead or pitch. The software also may determine whether the thread is within manufacturing tolerance (i.e., “in spec” or “out of spec”), for example by comparing the measurement data against a corresponding set of reference data.

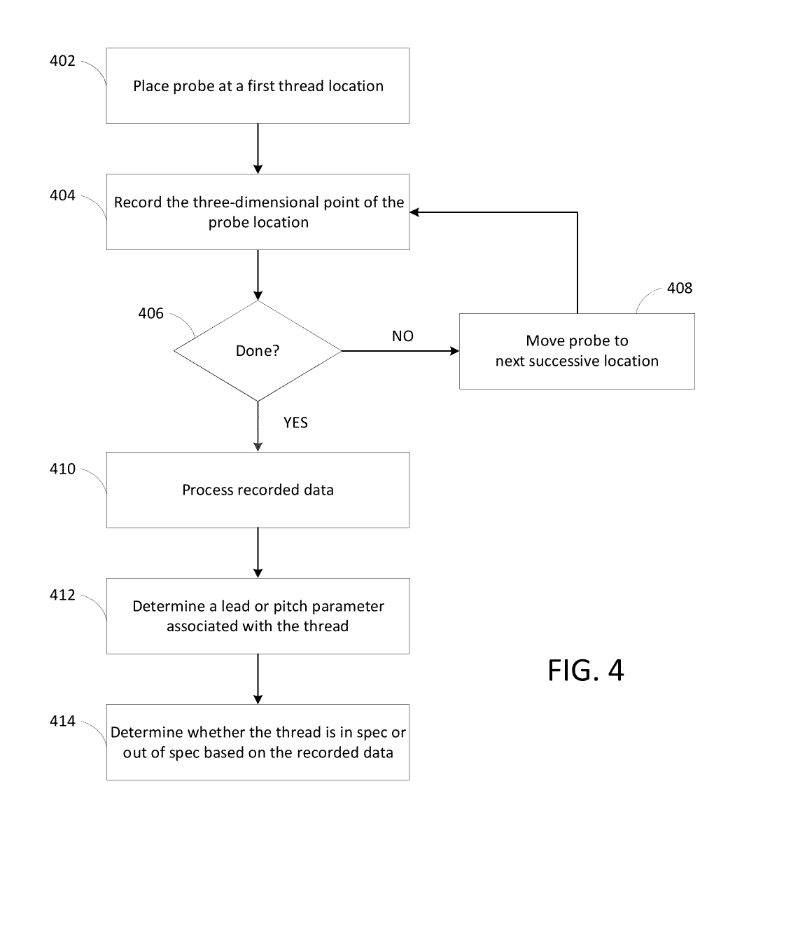

FIG. 4 is a logic flow diagram for thread measurement, in accordance with an exemplary embodiment. First, the probe is placed at a first thread location, in block 402. Then, the three-dimensional point of the probe location is recorded, in block 404. As long as additional measurements are to be taken (NO in block 406), the probe is moved to a next successive location, in block 408, and the three-dimensional point of the probe location is recorded. When the process is complete (YES in block 406), the recorded data may be processed in block 410, particularly to produce measurements of the three-dimensional distances between various points. This measurement data may be used, for example, to determine a parameter associated with the thread such as the lead or pitch, in block 412, or to determine whether the thread is in spec or out of spec, in block 414.

In certain alternative embodiments, the thread may be inspected using a laser probe may be used instead of a contact probe. Use of laser probes with measuring arms 1 are well known and is described in the aforementioned U.S. patent application Ser. No. 12/748,169. However, measuring with a laser scanner currently does not permit measurements to the same level of accuracy as a so-called hard probe, as is required in some applications involving threads for use in petroleum-based end uses. Moreover, the profile of a clipped thread with a reverse flank, such as the thread profile shown in FIG. 3, can obscure some of the thread profile and make it difficult for a laser beam to reach parts of the thread profile. In other words, the reverse flank obscures portions of the groove beneath the outer edge of the reverse flank and the clipped land. Moreover, a line laser in particular, unlike a hard probe, will not take a single initial point, so a user can establish an initial reference point for the initial measurement of the first thread. Alternatively, a point laser or other means for using a laser, which are known, could be used to set an initial reference measurement and subsequent measurements to obtain the three-dimensional distances between different portions of the thread as described herein.

In the exemplary embodiments discussed up to this point, the lead was measured by measuring the distance between two corresponding points on adjacent threads. However, the lead for an accumulation of thread starts may be measured using the same apparatus and process described herein. In other words, the lead measurement could be taken across one or more thread starts, as long as the number of the thread starts is known, or the lead measurement could be taken across all thread starts within a specified length.

It should also be noted that logic flows may be described herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. Computer program logic implementing some or all of the described functionality is typically implemented as a set of computer program instructions that is converted into a computer executable form, stored as such in a computer readable medium, and executed by a microprocessor under the control of an operating system. Hardware-based logic implementing some or all of the described functionality may be implemented using one or more appropriately configured FPGAs.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some embodiments of the invention may be implemented as a combination of both software (e.g., a computer program product) and hardware. Still other embodiments of the invention are implemented as entirely hardware, or entirely software.

Various embodiments of the present invention may be embodied in other specific forms without departing from the true scope of the invention, and numerous variations and modifications will be apparent to those skilled in the art based on the teachings herein. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. A computerized method for inspecting the thread of a threaded object, the method comprising:
placing a metrology probe at each of a number of successive locations on the thread, the metrology probe being adjustable using an articulating arm;
recording a three-dimensional point of the said thread locations by a computerized metrology system coupled to the articulating arm; and
using the computerized metrology system, producing data characterizing the thread as a function of the recorded three-dimensional points of the said thread locations.

2. A method according to claim 1, wherein the threaded object includes at least one of a pipe, a rod, a screw, a nut, a bolt, and a threaded insert.

3. A method according to claim 1, wherein the measurement data includes three-dimensional measurements of pairs of successive points.

4. A method according to claim 1, further comprising:
determining at least one thread characteristic based on the measurement data.

5. A method according to claim 4, wherein the thread characteristic includes at least one of lead and pitch.

6. A method according to claim 1, further comprising:
determining whether the thread is within predetermined specifications.

7. A method according to claim 6, wherein determining whether the thread is within predetermined specifications comprises comparing the measurement data to a set of reference data.

8. A method according to claim 1, wherein a position and an orientation of the articulating arm are controlled by the computerized metrology system.

9. A computerized thread measurement system for inspecting the thread of a threaded object, the system comprising:
an articulating probe arm having a metrology probe; and
a computerized metrology system in communication with the probe arm, the computerized metrology system configured to:
adjust the position and orientation of the probe arm,
record a three-dimensional point of the probe at each of a number of successive thread locations, and
produce measurement data characterizing the thread.

10. A system according to claim 9, wherein the threaded object includes at least one of a pipe, a rod, a screw, a nut, a bolt, and a threaded insert.

11. A system according to claim 9, wherein the measurement data includes three-dimensional measurements of pairs of successive points.

12. A system according to claim 9, wherein the computerized metrology system is further configured to determine at least one thread characteristic based on the measurement data.

13. A system according to claim 12, wherein the thread characteristic includes at least one of lead and pitch.

14. A system according to claim 9, wherein the computerized metrology system is further configured to determine whether the thread is within predetermined specifications.

15. A system according to claim 14, wherein the computerized metrology system is configured to determine whether the thread is within predetermined specifications by comparing the measurement data to a set of reference data.

16. A system according to claim 9, wherein the computerized metrology system is further configured to place the probe at one or more of the successive probe locations.

17. A system according to claim 9, wherein the metrology probe is a ruby ball stylus probe.

18. Apparatus comprising a tangible, non-transitory computer-readable medium having embodied therein instructions for inspecting the thread of a threaded object, the instructions, when run on a computerized metrology system including a probe arm having a metrology probe, causing the computerized metrology system to perform the processes of:
placing the metrology probe at each of a number of successive locations on the thread,
recording a three-dimensional point of the probe at each of the number of successive locations; and
producing measurement data characterizing the thread.

19. Apparatus according to claim 18, wherein the threaded object includes at least one of a pipe, a rod, a screw, a nut, a bolt, and a threaded insert.

20. Apparatus according to claim 18, wherein the measurement data includes three-dimensional measurements of pairs of successive points.

21. Apparatus according to claim 18, further comprising:
instructions for determining at least one thread characteristic based on the measurement data.

22. Apparatus according to claim 21, wherein the thread characteristic includes at least one of lead and pitch.

23. Apparatus according to claim 18, further comprising:
instructions for determining whether the thread is within predetermined specifications.

24. Apparatus according to claim 23, wherein the instructions for determining whether the thread is within predetermined specifications include instructions for comparing the measurement data to a set of reference data.

25. Apparatus according to claim 18, further comprising:
instructions for placing the probe at one or more of the successive probe locations.
